(19) United States
(12) Patent Application Publication
(10) Pub. No.: US 2016/0104374 A1
(43) Pub. Date: Apr. 14, 2016

(54) SECONDARY SECURITY AND AUTHENTICATION FOR TRAINABLE TRANSCEIVER

(71) Applicant: GENTEX CORPORATION, Zeeland, MI (US)

(72) Inventors: Kenton J. YPMA, Zeeland, MI (US); Nolan R. FABER, Zeeland, MI (US)

(73) Assignee: GENTEX CORPORATION, Zeeland, MI (US)

(21) Appl. No.: 14/877,717

(22) Filed: Oct. 7, 2015

Related U.S. Application Data
(60) Provisional application No. 62/061,594, filed on Oct. 8, 2014.

(51) Int. Cl. G08C 17/02; G07C 9/00

(52) U.S. Cl. CPC G08C 17/02; G07C 9/00007; G08C 2201/20

(57) ABSTRACT

A transmitter for mounting to a vehicle and for sending a transmission to a remote system is shown and described. The transmitter includes a processing circuit, a transmitter, and a battery powering the processing circuit and the transmitter. The processing circuit is configured to restrict transmission to the remote system unless a security module checks one or more parameters.

CROSS-REFERENCE TO RELATED PATENT APPLICATIONS

This application claims the benefit of and to U.S. Provisional Application No. 62/061,594, filed Oct. 8, 2014, which is hereby incorporated by reference in its entirety.

### BACKGROUND

The present invention relates generally to the field of vehicles, and more particularly to the use of a trainable transceiver (e.g., garage door opener) in vehicles.

A vehicle may include a trainable transceiver for operating, for example, a garage door, security gate, home lighting system, or home security system. A battery-powered trainable transceiver may be active in the vehicle regardless of whether the vehicle ignition is activated or not. This may create a security risk where access to the house can be gained by simply pushing a single trainable transceiver button (i.e., if the vehicle is parked in a driveway). Such a security risk may be a deterrent to adoption of battery powered trainable transceivers in a vehicle.

### SUMMARY

One embodiment of the invention relates to a transmitter device for mounting to a vehicle and for sending a transmission to a remote system. The device includes a processing circuit, a transmitter, and a battery powering the processing circuit and the transmitter. The processing circuit is only configured to use the transmitter to send the transmission to the remote system upon determining at least one of: (a) a user's portable electronic device is near the vehicle, and (b) the vehicle is powered on.

Another embodiment relates to a transmitter device for activating a remote system. The device includes a processing circuit, a transmitter coupled to the processing circuit, a battery powering the processing circuit and the transmitter, and a plurality of buttons coupled to the processing circuit. The processing circuit is configured to allow a transmission from the transmitter to the remote system in response to a determination that a user has entered a correct multi-button code at the plurality of buttons.

Another embodiment relates to a trainable transceiver unit for mounting in a vehicle. The trainable transceiver unit includes a transmitter, a user input interface, a security module, and a processing circuit. The transmitter is configured to transmit a remote control signal for controlling operation of a remote electronic signal. The user input interface is configured to receive a request for transmission of the remote control signal. The security module is configured to receive a security input signal, compare the security input signal to a stored valid security code, and transmit a security control signal to a processing circuit based on the comparison. The processing circuit is configured to prevent operation of the transmitter unless the security control signal indicates operation of the transmitter is authorized.

Another embodiment relates to a method of operating a trainable transceiver unit. The method includes receiving a security input signal at a security module of the trainable transceiver unit. The method includes validating the security input signal at the security module. The method includes generating a security control signal at the security module based on the validating, wherein the security control signal has an authorized value if the security input signal is determined to be valid, and the security control signal has a not authorized value if the security input signal is determined to not be valid. The method include transmitting the security control signal to a processing circuit, wherein the processing circuit authorizes operation of a transmitter based on the security control signal.

Another embodiment relates to a method of operating a trainable transceiver unit. The method includes receiving a user input signal at a user interface of the trainable transceiver unit, and transmitting the user input signal to a processing circuit of the trainable transceiver unit. The method includes receiving a security status from a security module at the processing circuit. The method includes determining at the processing circuit whether the current security status is one of authorized or not authorized. The method includes generating a security control signal at the processing circuit based on the security status, the security control signal indicating whether operation of a transmitter of the trainable transceiver unit is authorized.

Another embodiment relates to a method of operating a trainable transceiver unit. The method includes receiving a security input signal at a security module of the trainable transceiver unit. The method includes validating the security input signal at the security module. The method includes determining whether the security input signal is valid. The method includes requesting an override input in response to determining that the security input is not valid. The method includes generating a security control signal indicating operation of a transmitter of the trainable transceiver unit is not authorized in response to determining that the override input is not valid. The method includes generating a security control signal indicating operation of the transmitter is valid in response to determining that the security input signal is valid or in response to determining that the override input is valid.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 illustrates a perspective view of a vehicle and a garage according to an exemplary embodiment.

FIG. 2 illustrates a block diagram of a system including a transceiver unit and a remote electronic system according to an exemplary embodiment.

FIG. 3 illustrates a schematic diagram of a trainable transceiver unit according to an exemplary embodiment.

FIG. 4 illustrates a schematic diagram of a trainable transceiver unit according to another exemplary embodiment.

FIG. 5 illustrates a schematic diagram of a trainable transceiver unit according to another exemplary embodiment.

FIG. 6 illustrates a schematic diagram of a trainable transceiver unit according to another exemplary embodiment.

FIG. 7 illustrates a schematic diagram of a trainable transceiver unit according to another exemplary embodiment.

FIG. 8 illustrates a schematic diagram of a trainable transceiver unit according to another exemplary embodiment.

FIG. 9 illustrates a flow diagram of a method of using a trainable transceiver unit using authentication according to an exemplary embodiment.

FIG. 10 illustrates a flow diagram of a method of using a trainable transceiver unit using a security status according to an exemplary embodiment.

FIG. 11 illustrates a flow diagram of a method of using a trainable transceiver unit using authentication and override input according to an exemplary embodiment.

### DETAILED DESCRIPTION

Referring generally to the FIGURES, devices and methods are shown and described for allowing a battery powered trainable transceiver (or transmitter, if the training is handled via other than RF reception) to actuate only in the event of some additional factor of authentication. In cases where the trainable transceiver is battery powered, a direct line of power/trigger may not be connected to the vehicle ignition or wired to another vehicle part. This may particularly be the case for a retrofit trainable transceiver. This disclosure advantageously adds a layer of security. When a button is pressed on the trainable transceiver (e.g., to open Garage door 1), the trainable transceiver (i.e., a processor thereof) only conducts the transmission of a signal to the remote system (e.g., garage door opener) if an additional authentication parameter is detected. A variety of embodiments are described in detail herein.

One implementation may operate using a small secondary FOB (e.g., for coupling to a key chain) for wireless communication with the trainable transceiver. The trainable transceiver, in such an embodiment, would only conduct the transmission to the remote system if the FOB were successfully detected as being within a short range distance to the vehicle. In another implementation, the trainable transceiver may sense the vibration of a vehicle to determine it is running In response to a determination that the vehicle is running, the trainable transceiver can then conduct the transmission. The vibration, detected by a vibration sensor, may indicate that the true owner has the car started and is authorized to open the garage door. In another implementation, the trainable transceiver may be installed as battery powered (i.e., not having or requiring a hardwired power connection to the vehicle), but a small module (e.g., wireless) is configured to sense power (e.g., current) in an ignition line. The trainable transceiver would then be able to conduct its transmission any time the small module detects that the ignition is active. In other embodiments of the disclosure, the trainable transceiver may have multiple buttons. A multi-button combination may serve as a passcode for use of the trainable transceiver. In one embodiment, the multi-button code ends with the garage door button associated with the garage door the user wishes to open. In other embodiments, the successful entry of the multi-button combination may allow transmissions for a period of time after the successful entry (e.g., 30 seconds, one minute, etc.). In another implementation, different multi-button combinations could be associated with different transmission codes (e.g., different garage doors). Upon direct entry of the appropriate multi-button combination, the trainable transceiver conducts its transmission of the appropriate code. In yet other embodiments, a mobile phone, smart watch, or another portable electronic device carried by a user can be used to trigger authentication of the trainable transceiver via wireless (e.g., Bluetooth, WiFi, NFC, etc.) communications.

For the next few paragraphs, general operation of a trainable transceiver will now be described. The trainable transceiver unit may be configured to “learn” the characteristics of multiple remote control signals generated by multiple remote control devices (e.g., a remote control for a garage door, a security gate, a home lighting system, a home security system, etc.) and store an indication of the multiple remote control signals in a local memory thereof for subsequent retransmission. The trainable transceiver unit may reproduce a stored control signal upon receiving a user input (e.g., via a push button, a voice command, etc.) and may transmit the stored control signal for operating a remote electronic system or device.

The trainable transceiver unit may be integrated within a vehicle system component such as a rear view mirror, an instrument panel, a headliner, or other locations within the vehicle. Advantageously, the trainable transceiver unit may be installed quickly and easily into an existing vehicle (e.g., as part of a vehicle upgrade or retrofit) without requiring extensive integration with the existing vehicle system. For example, the trainable transceiver unit may be a standalone device capable of independent and self-sufficient operation without relying on input from a vehicle subsystem or energy from the main vehicle battery. The trainable transceiver unit may include all the necessary processing electronics for learning, storing, and retransmitting a control signal. The trainable transceiver unit may further include a battery (e.g., separate from the main vehicle battery) used to power only the trainable transceiver unit.

In some embodiments, the trainable transceiver unit is integrated with a rear view mirror assembly for the vehicle. For example, the trainable transceiver unit may include a battery and a transceiver circuit mounted between a front reflective surface (e.g., the mirror) and a back housing of the rear view mirror assembly. The trainable transceiver unit may include one or more user input devices for controlling collection and retransmission of a remote control signal.

The trainable transceiver unit may include a voltage regulator circuit with a DC-DC converter, a low leakage switch, and a temperature-sensitive current source. The DC-DC converter may be used to increase the power supplied by the battery, thereby extending battery life and reducing the need for battery replacement. The battery may be a long-life battery (e.g., a lithium battery, a lithium-thionyl chloride cell, etc.) configured to operate within a range of typical automotive temperatures. The low leakage switch may be used to govern how much current is available to the DC-DC converter, while the temperature-sensitive current source may be used to adjust the low leakage switch.

Advantageously, the trainable transceiver unit may include a security module. The security module may generate a security control signal in order to restrict operation of the trainable transceiver unit. The security module may generate the security control signal based on a security input signal received from some other component, e.g., from an adjacent security fob, from a vibration sensor, from an ignition line power detector, etc. With use of the security module, the trainable transceiver unit may be able to restrict operation of the trainable transceiver unit to only authorized users. This may prevent security vulnerabilities that would otherwise be present if the security module were not used.

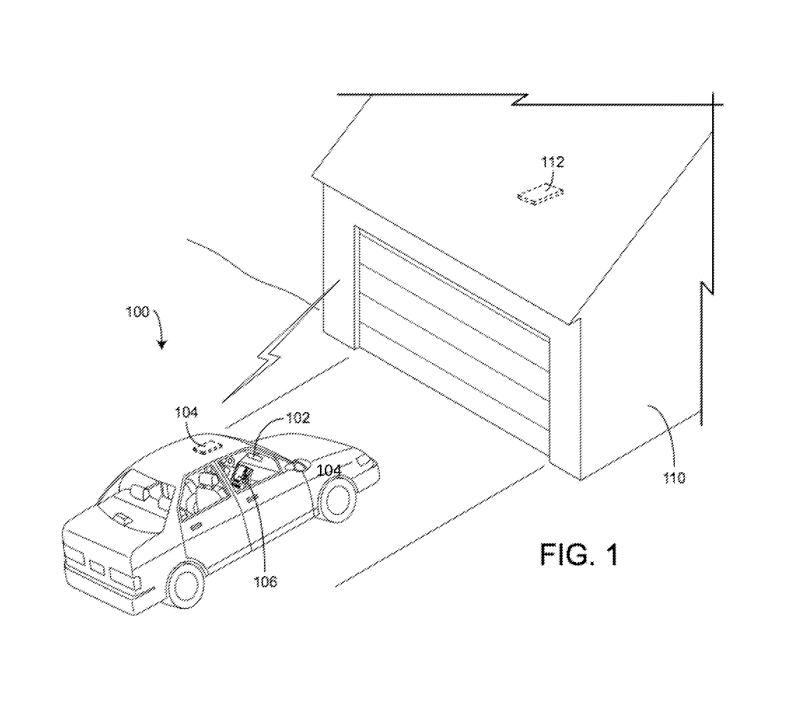

Referring now to FIG. 1, a perspective view of a vehicle 100 and garage 110 is shown, according to an exemplary embodiment. Vehicle 100 may be an automobile, truck, sport utility vehicle (SUV), mini-van, or other vehicle. Vehicle 100 is shown to include a trainable transceiver unit 102. In some embodiments, trainable transceiver unit 102 may be integrated with a mirror assembly (e.g., a rear view mirror assembly) of vehicle 100. In other embodiments, trainable transceiver unit 102 may be mounted to other vehicle interior elements, such as a vehicle headliner 104, a center stack 106, a visor, an instrument panel, or other control unit within vehicle 100.

Advantageously, trainable transceiver unit 102 may be configured for quick and easy installation into vehicle 100. For example, for embodiments in which trainable transceiver unit 102 is integrated with a rear view mirror assembly, installation may require only swapping an existing rear view mirror assembly for the integrated rear view mirror display and trainable transceiver unit assembly. Trainable transceiver unit 102 may include all the electronic components for self-sufficient operation (e.g., a control circuit, a transceiver circuit, a battery, etc.) without requiring a wired power or data connection to another vehicle system component.

Advantageously, trainable transceiver unit 102 may be configured to operate a security module contained therein without the requirement to physically attach the trainable transceiver unit 102 to the electrical system of the vehicle 100. In some embodiments, the security module may be effective to restrict transmission of a control signal from the trainable transceiver unit 102 to situations where the vehicle is running The security module may be able to determine whether the vehicle is running even without being directly wired to the ignition subsystem of the vehicle 100. In other words, the trainable transceiver does not receive its primary power from the vehicle. In some embodiments, the security module may be able to determine the presence of an authorized key fob (and thus by presumption an authorized operator of vehicle 100) even without being directly wired to or receiving control signals from the ignition subsystem of the vehicle 100.

Trainable transceiver unit 102 is configured to communicate with a remote electronic system 112 of a garage 110 or other structure. In some embodiments, remote electronic system 112 is configured to control operation of a garage door attached to garage 110. In other embodiments, remote electronic system 112 may be a home lighting system, a home security system, a data network (e.g., LAN, WAN, cellular, etc.), a HVAC system, or any other remote electronic system capable of receiving control signals from trainable transceiver unit 102.

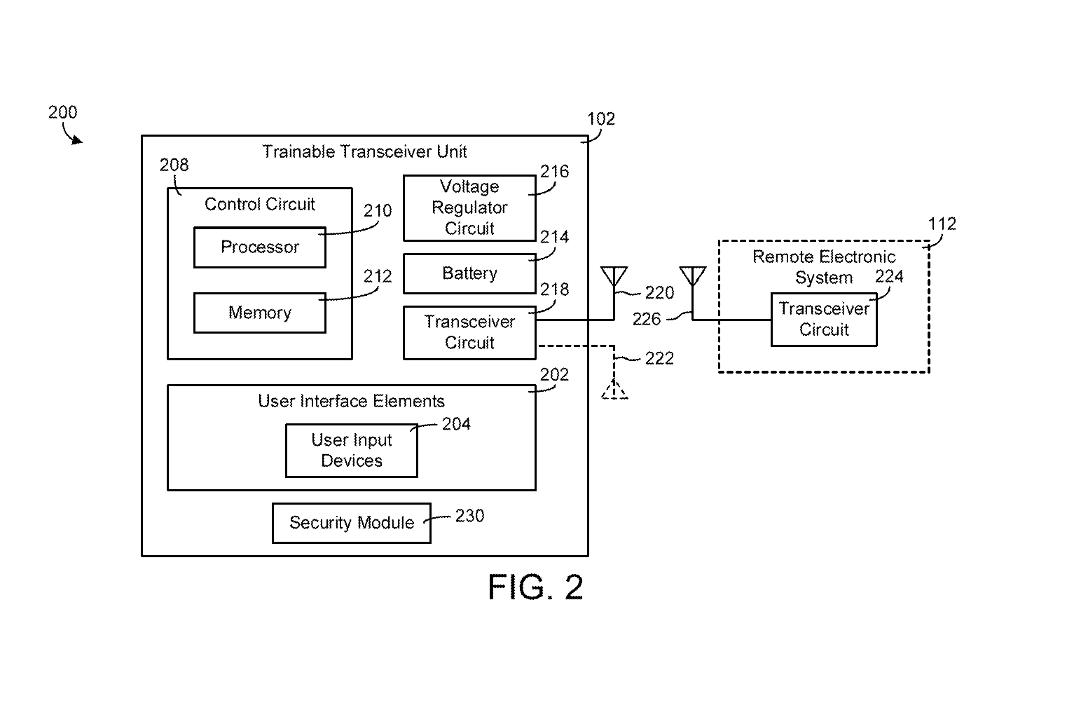

Referring now to FIG. 2, a block diagram of a system 200 including a trainable transceiver unit 102 and a remote electronic system 112 is shown, according to an exemplary embodiment. In brief overview, trainable transceiver unit 102 is shown to include user interface elements 202, a control circuit 208, a battery 214, a voltage regulator circuit 216, a transceiver circuit 218, and a security module 230.

User interface elements 202 may facilitate communication between a user (e.g., driver, passenger, or other occupant of vehicle 100) and trainable transceiver unit 102. For example, user interface elements 202 may be used to receive input from a user. User interface elements 202 are shown to include user input devices 204.

In some embodiments, user input devices 204 include one or more push buttons, switches, dials, knobs, touch-sensitive user input devices (e.g., piezoelectric sensors, capacitive touch sensors, etc.), or other devices for translating a tactile input into an electronic data signal. Advantageously, user input devices 204 may be integrated with a rear view mirror assembly of vehicle 100. For example, user input devices 204 may include one or more pushbuttons (e.g., mounted along a bottom surface of a rear view mirror assembly). User input devices 204 may provide input signals to control circuit 208 for controlling operation of trainable transceiver unit 102.

Still referring to FIG. 2, trainable transceiver unit 102 is shown to include a control circuit 208. Control circuit 208 may be configured to receive input from user input devices 204. Control circuit 208 may further be configured to operate transceiver circuit 218 for conducting electronic data communications with remote electronic system 112. Control circuit 208 may further be configured to receive input (e.g., a security control signal) from security module 230.

Control circuit 208 is shown to include a processor 210 and memory 212. Processor 210 may be implemented as a general purpose processor, a microprocessor, a microcontroller, an application specific integrated circuit (ASIC), one or more field programmable gate arrays (FPGAs), a CPU, a GPU, a group of processing components, or other suitable electronic processing components.

Memory 212 may include one or more devices (e.g., RAM, ROM, Flash® memory, hard disk storage, etc.) for storing data and/or computer code for completing and/or facilitating the various processes, layers, and modules described in the present disclosure. Memory 212 may comprise volatile memory or non-volatile memory. Memory 212 may include database components, object code components, script components, or any other type of information structure for supporting the various activities and information structures described in the present disclosure. In some implementations, memory 212 is communicably connected to processor 210 via control circuit 208 and includes computer code (e.g., data modules stored in memory 212) for executing one or more control processes described herein.

Still referring to FIG. 2, trainable transceiver unit 102 is shown to include a battery 214. Battery 214 may be configured to supply power to the various electronic components of trainable transceiver unit 102. Battery 214 may be separate from the main vehicle battery used to power other systems and subsystems of vehicle 100 (e.g., a stereo system, a navigation system, a lighting system, etc.). In some embodiments, battery 214 may be used to power only trainable transceiver unit 102. Trainable transceiver unit 102 may receive power from only battery 214 without relying on other supplemental or alternative power sources. Advantageously, battery 214 may facilitate operation of trainable transceiver unit 102 independent from the main vehicle battery and vehicle power line, thereby insulating trainable transceiver unit 102 from undesirable vehicle power line noise.

In some embodiments, battery 214 may be installed within a rear view mirror assembly of vehicle 100 (e.g., between the mirror and back housing). For implementations in which trainable transceiver unit 102 is integrated with a rear view mirror display, the integrated product may be sold and installed as a standalone unit. Locating battery 214 within the rear view mirror assembly may allow trainable transceiver unit 102 to operate independently without requiring wiring connections to any other component of vehicle 100. This advantage may facilitate installation of trainable transceiver unit 102 by eliminating the need to disassemble vehicle 100 to run power cables from a main vehicle power line to trainable transceiver unit 102. Any necessary power cables or other wiring connections may be contained entirely within the rear view mirror assembly. Battery 214 may be configured to be quickly and easily replaced without requiring substantial disassembly or rewiring.

Battery 214 may be a long-life battery configured to reliably provide power over an extended period of time (e.g., 1 year, 2 years, 5 years, 10 years, etc.). In some embodiments, battery 214 is a lithium cell battery or other battery having a high power density. For example, battery 214 may include a lithium-thionyl chloride energy cell. The lithium-thionyl chloride energy cell may contain a liquid mixture of thionyl chloride (i.e., SOCl2) and lithium tetrachloroaluminate (i.e., LiAlCl4). The thionyl chloride may act as a cathode for the energy cell and the lithium tetrachloroaluminate may act as an electrolyte for the energy cell. Lithium-thionyl chloride batteries may be well suited for extremely low-current applications where long battery life is necessary or desirable. In some embodiments, battery 214 includes a porous carbon material. The porous carbon material may function as a cathode current collector (e.g., for receiving electrons from an external circuit).

Battery 214 may be configured to have a low self-discharge rate. Advantageously, a high energy or power density in combination with a low self-discharge rate may contribute to battery 214 reliably providing power for an extended period of time. The high energy or power density in combination with the low self-discharge rate may also qualify battery 214 as a long-life battery.

Battery 214 may store energy chemically and/or electrically. For example, in some embodiments, battery 214 includes a capacitive element configured to store electrical energy. In some embodiments, battery 214 includes a “hybrid layer capacitor” used with a lithium cell. The hybrid layer capacitor may be the same as or similar to the hybrid layer capacitors sold by Tadiran Batteries. For example, a hybrid layer capacitor may be a type of rechargeable battery. A hybrid layer capacitor may include electrodes including lithium intercalation compounds. A hybrid layer capacitor generally has a low impedance and can deliver high current pulses. One or more hybrid layer capacitors may be connected in parallel with the lithium cell.

Still referring to FIG. 2, trainable transceiver unit 102 is shown to include a transceiver circuit 218 and an antenna 220. Transceiver circuit 218 may include transmit and/or receive circuitry configured to communicate via antenna 220 with remote electronic system 112. Transceiver circuit 218 may be configured to transmit wireless control signals having control data for controlling remote electronic system 112. Transceiver circuit 218 may be further configured to receive wireless status signals including status information from remote electronic system 112. Trainable transceiver unit 102 and remote electronic system 112 may communicate using any suitable wireless standard (e.g., Bluetooth, WiFi, WiMax, etc.) or other communications protocols compatible with or proprietary to remote electronic system 112. Trainable transceiver unit 102 may be configured to learn and replicate control signals using any wireless communications protocol.

In a training mode of operation, transceiver circuit 218 may be configured to receive one or more characteristics of an activation signal sent from an original transmitter for use with remote electronic system 112. An original transmitter may be a remote or hand-held transmitter, which may be sold with remote electronic system 112 or as an after-market item. The original transmitter may be configured to transmit an activation signal at a predetermined carrier frequency and having control data configured to actuate remote electronic system 112. For example, the original transmitter may be a hand-held garage door opener transmitter configured to transmit a garage door opener signal at a frequency (e.g., centered around 315 MHz or 355 MHz, etc.). The activation signal may include control data, which can be a fixed code, a rolling code, or another cryptographically-encoded code. Remote electronic system 112 may be configured to open a garage door, for example, in response to receiving the activation signal from the original transmitter.

Transceiver circuit 218 may be configured to identify and store one or more characteristics of the activation signal (e.g., signal frequency, control data, modulation scheme, etc.) from the original transmitter or from another source. In some embodiments, transceiver circuit 218 is configured to learn at least one characteristic of the activation signal by receiving the activation signal, determining the frequency of the activation signal, and/or demodulating the control data from the activation signal. Alternatively, trainable transceiver unit 102 can receive one or more characteristics of the activation signal by other methods of learning. For example, the one or more characteristics of the activation signal can be preprogrammed into memory 212 during manufacture of trainable transceiver unit 102, input via user input devices 204, or learned via a “guess and test” method. In this manner, trainable transceiver unit 102 need not actually receive the activation signal from an original transmitter in order to identify characteristics of the activation signal. Trainable transceiver unit 102 may store the characteristics of the activation signal in memory 212.

In some embodiments, transceiver circuit 218 is configured to integrate the original transmitter as part of the wireless control system. For example, operation of the original transmitter within range of trainable transceiver unit 102 may provide an activation signal to transceiver circuit 218, indicating that the signal was also sent to remote electronic system 112. In some embodiments, transceiver circuit 218 eliminates the need for continued use of the original transmitter after training is complete.

Transceiver circuit 218 may be configured to generate a carrier frequency at any of a number of frequencies (e.g., in response to a control signal from control circuit 208). In some embodiments, the frequencies generated can be in the ultra-high frequency range (e.g., between 20 and 470 megahertz (MHz), between about 20 and 950 MHz, between about 280 and 434 MHz, up to 868 MHz, up to 920 MHz, up to 960 MHz, etc.) or in other frequency ranges. The control data modulated with the carrier frequency signal may be frequency shift key (FSK) modulated, amplitude shift key (ASK) modulated, or modulated using another modulation technique. Transceiver circuit 218 may be configured to generate a wireless control signal having a fixed code, a rolling code, or other cryptographically encoded control code suitable for use with remote electronic system 112.

Transceiver circuit 218 may use antenna 220 to increase a range or signal quality of the communications between trainable transceiver unit 102 and remote electronic system 112. In some embodiments, antenna 220 is a monopole antenna including a single antenna branch. In other embodiments, a second antenna branch 222 may be used. Antenna branch 222 and antenna 220 may be arranged in a dipole configuration (e.g., extending in opposite directions from an antenna stem, as a dipole loop, etc.). The dipole configuration may improve system performance by preventing resonance at an undesirable frequency.

Still referring to FIG. 2, trainable transceiver unit 102 is shown to include a security module 230. Security module 230 may include a processor, storage medium, transceiver, and other hardware features. Security module 230 may receive a security input signal. Security module 230 may generate a security control signal based on the received security input signal. Security module 230 may generate the security control signal based on validating the received security input signal against data stored as part of security module 230, in memory 212, or elsewhere on trainable transceiver unit 102. Security module 230 may transmit or otherwise provide the security control signal to control circuit 208. Control circuit 208 may operate transceiver circuit 218 based on the received security control signal. For example, if the security control signal indicates a “not authorized” value, then control circuit 208 may prevent transceiver circuit 218 from transmitting a control signal to remote electronic system 112, regardless of input received from user input devices 204. If the security control signal indicates an “authorized” value, then control circuit 208 may cause transceiver circuit 218 to transmit a control signal to remote electronic system 112 based on receiving an input from user input devices 204. Security module 230 may provide a “not authorized” value as a default value to control circuit 208.

Security module 230 may be configured to redundantly validate the received security input signal against data stored as part of security module 230, in memory 212, or elsewhere on trainable transceiver unit 102. For example, security module 230 may associate security input signals from multiple sources with a particular remote electronic system 112, such that a security control signal indicating an “authorized” value may be generated based on various conditions.

Still referring to FIG. 2, system 200 is shown to include a remote electronic system 112. Remote electronic system 112 may be any of a plurality of remote electronic systems, such as a garage door opener (as shown in FIG. 1), security gate control system, security lights, remote lighting fixtures or appliances, a home security system, or another set of remote devices. Remote electronic system 112 is shown to include a transceiver circuit 224 and an antenna 226. Transceiver circuit 224 includes transmit and/or receive circuitry configured to communicate via antenna 226 with trainable transceiver unit 102. Transceiver circuit 224 may be configured to receive wireless control signals from trainable transceiver unit 102. The wireless control signals may include control data for controlling operation of remote electronic system 112.

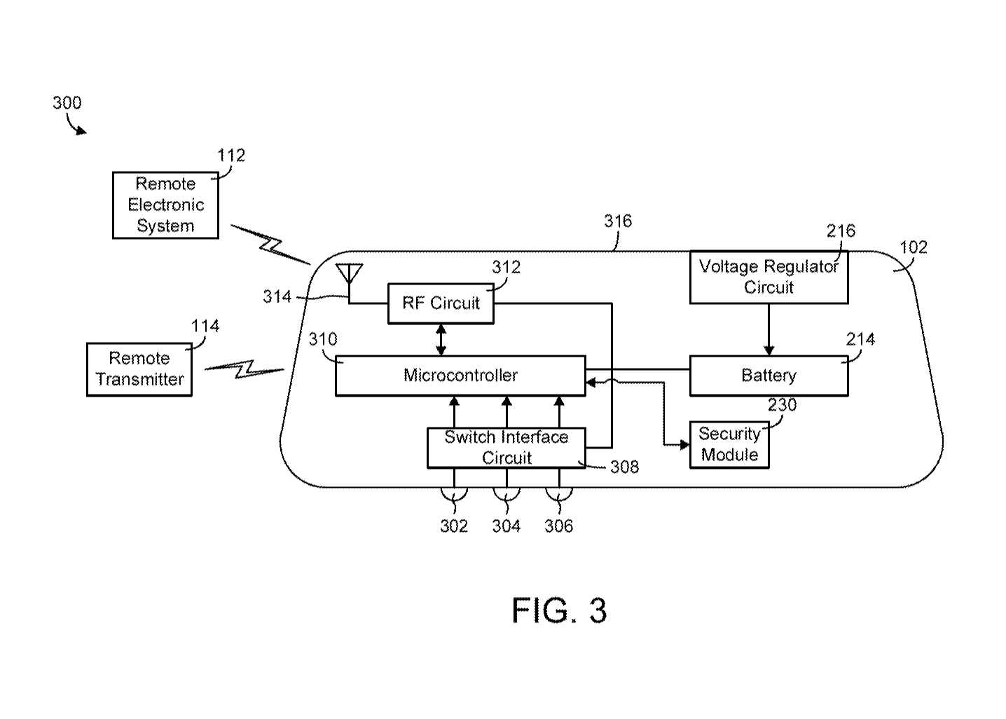

Referring now to FIG. 3, an electrical schematic diagram 300 of trainable transceiver unit 102 is shown, according to an exemplary embodiment. Schematic diagram 300 illustrates the data and power connections within trainable transceiver unit 102 as well the electronic data communications between trainable transceiver unit 102, remote electronic system 112, and remote transmitter 114.

Schematic diagram 300 is shown to include several of the components of trainable transceiver unit 102 previously described with reference to FIG. 2. For example, schematic diagram 300 is shown to include battery 214, voltage regulator circuit 216, and security module 230. Schematic diagram 300 is shown to further include several additional components including buttons 302, 304, and 306, a switch interface circuit 308, a microcontroller 310, and a RF circuit 312 with an attached antenna 314.

Notably, schematic diagram 300 illustrates the various components of trainable transceiver unit 102 within a housing 316. Housing 316 may be a perimeter frame, rear housing, or other boundary associated with a rear view mirror assembly. Advantageously, all components of trainable transceiver unit 102 may be located within or mounted upon housing 316.

Still referring to FIG. 3, schematic diagram 300 is shown to include buttons 302, 304, and 306. Buttons 302-306 may be an embodiment of user input devices 204, as previously described with reference to FIG. 2. For example, buttons 302-306 may be user operable input devices for controlling operation of trainable transceiver unit 102. Each of buttons 302-306 may be associated with (e.g., trained, programmed, configured to operate, etc.) a different remote device controllable by trainable transceiver unit 102. For example, button 302 may be associated with a garage door system, button 304 may be associated with an access gate system, and button 306 may be associated with a home lighting system. Buttons 302-306 may include any number of buttons and may be configured to operate any number of remote electronic systems 112.

In some embodiments, each remote electronic system 112 controlled by trainable transceiver unit 102 requires a control signal having different signal characteristics (e.g., operating frequency, modulation scheme, security code, etc.). Each of buttons 302-306 may cause trainable transceiver unit 102 to emit a control signal having different signal characteristics (e.g., for controlling multiple remote electronic systems with a single trainable transceiver unit). In some embodiments, buttons 302-306 may be pushbutton switches which complete an electrical path within switch interface circuit 308 when pushed.

Switch interface circuit 308 may be a circuit element configured to translate a user input received via buttons 302-306 into an electrical signal for transmission to microcontroller 310. Switch interface circuit 308 may receive an electric current and/or voltage from battery 214 and selectively deliver the received current and/or voltage to a particular port of microcontroller 310. In some embodiments, switch interface circuit 308 delivers the electric current and/or voltage to a microcontroller port in response to a user selection of buttons 302-306. The particular port of microcontroller 310 to which switch interface circuit 308 routes current and/or voltage may depend on which of buttons 302-306 is pressed. Thus, microcontroller 310 may receive a different input from switch interface circuit 308 (e.g., an input received at a different microcontroller port) based on which of buttons 302-306 is pressed. In some embodiments, switch interface circuit 308 includes a capacitive element configured to prevent battery 214 from discharging in the event that one of buttons 302-306 is maintained in a pressed condition (e.g., held by a user, stuck in a pressed position, etc.).

In an exemplary embodiment, the buttons 302-306 may interface with the security module (e.g., via the microcontroller). The microcontroller may be configured to allow the transmission from the transmitter to the remote system in response to a determination that a user has entered the correct multi-button code at the plurality of buttons. A subsequent button press may trigger the actual transmission after the transmission has been allowed by the correct multi-button code. Alternatively, the last button pressed in the multi-button code activates a transmission previously stored in connection with that button. The multi-button code may differ from other possible multi-button codes and different multi-button codes may be associated with different transmissions to be made from the transmitter to the remote system.

In some embodiments, the buttons 302-306 may be configured to receive an override code in the event it is not possible to otherwise generate a security input signal that will result in a security control signal having an “authorized” value. For example, an override code such as a code unique to trainable transceiver unit 102, to security module 230, to remote electronic system 112, and/or to remote transmitter 114, may be stored in a storage medium of trainable transceiver unit 102 or any components therein. Accordingly, the override mode may act as a substitute for other methods of authentication disclosed herein that may not be possible to perform. In some embodiments, the override code may be a one-time use code that expires after entry for authentication. For example, after authenticating with the one-time use code, a user may be required to contact a manufacturer of trainable transceiver unit 102 in order to receive a new override code that the manufacturer also updates in a storage medium of trainable transceiver unit 102 or any components therein. In some embodiments, trainable transceiver unit 102 and/or security module 230 generate an alert, notification, or other communication and transmit such a communication to a manufacturer and/or owner of trainable transceiver unit 102 to indicate that the override code has been used. In some embodiments, the override code is only stored in one of memory 212 and security module 230, such as in a read-only sector of memory 212 or security module 230.

Still referring to FIG. 3, schematic diagram 300 is shown to include a microcontroller 310 and a RF circuit 312. Microcontroller 310 and RF circuit 312 may be embodiments of control circuit 208 and transceiver circuit 218 as previously described with reference to FIG. 2. Microcontroller 310 may be configured to receive an input from switch interface circuit 308 and to operate display 206 and/or RF circuit 312 in response to the input. For example, microcontroller 310 may be configured to monitor or measure an amount of energy remaining in battery 214 (e.g., via a measured voltage, current, etc.).

RF circuit 312 may be configured to receive a control signal from remote transmitter 114 (e.g., during a training mode of operation), to identify one or more characteristics of the control signal (e.g., frequency, control data, modulation scheme, etc.), and to store the control signal characteristics in a local memory of trainable transceiver unit 102. RF circuit 312 may receive and store any number of control signal characteristics corresponding to any number of remote transmitters 114.

RF circuit 312 may be configured to reproduce the control signal in response to an input received from microcontroller 310. For example, in response to a first input received from microcontroller 310 (e.g., caused by a user pressing button 302), RF circuit 312 may reproduce and transmit a first control signal via antenna 314. In response to a second input received from microcontroller 310 (e.g., caused by a user pressing button 304), RF circuit 312 may reproduce and transmit a second control signal via antenna 314. In response to a third input received from microcontroller 310 (e.g., caused by a user pressing button 306), RF circuit 312 may reproduce and transmit a third control signal via antenna 314. Advantageously, RF circuit 312 may be capable of reproducing any number of control signals for operating any number of remote electronic systems 112.

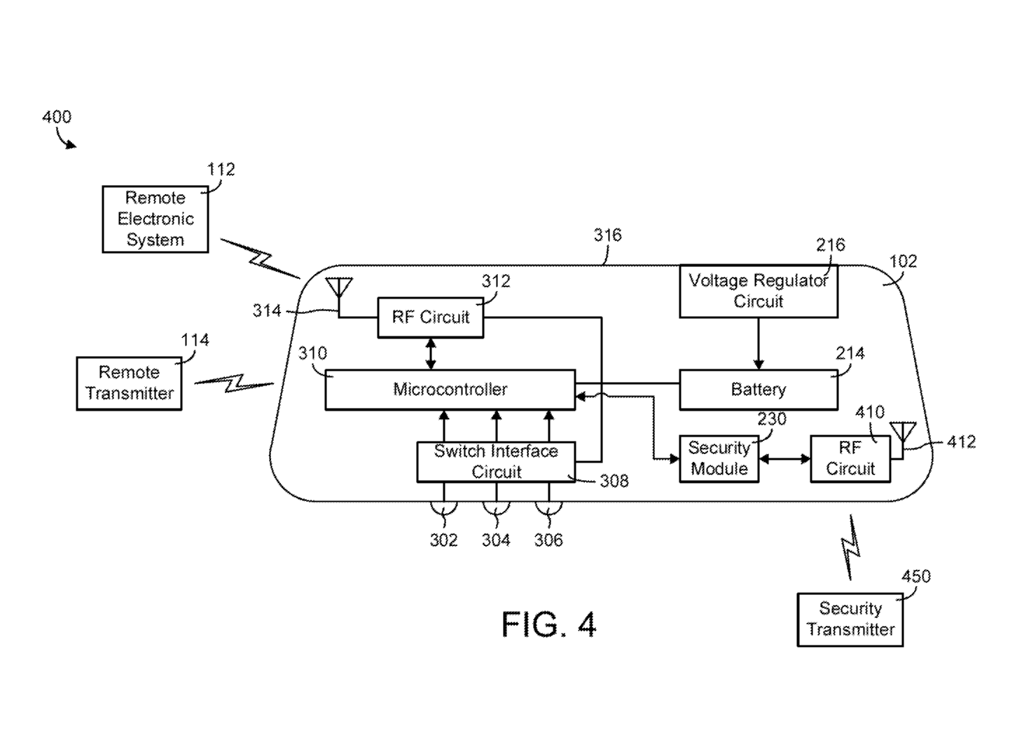

Still referring to FIG. 3, security module 230 is shown having a connection to microcontroller 310. Security module 230 may provide a security control signal to microcontroller 310 in order to enable or disable transmission of control signals using RF Circuit 312, such as described with respect to control circuit 208 and transceiver circuit 218 of FIG. 2. Security module 230 may generate the security control signal based on receiving a security input signal, described in greater detail with respect to FIGS. 4-8. In some embodiments, further communications between security module 230 and microcontroller 310 may be implemented. For example, security module 230 may transmit the security control signal to microcontroller 310 in response to receiving a request for the security control signal from microcontroller 310. As another example, security module 230 may request security data (e.g., valid key fob codes, valid vibration patterns, etc.) stored on a storage medium of trainable transceiver unit 102. Microcontroller 310 may retrieve the requested stored security data and transmit it to security module 230. Security module 230 may then use the received security data in order to validate the security input signal received by security module 230.

Referring now to FIG. 4, an electrical schematic diagram 400 of trainable transceiver unit 102 is shown, according to an exemplary embodiment. Schematic diagram 400 illustrates the data and power connections within trainable transceiver unit 102 as well the electronic data communications between trainable transceiver unit 102, remote electronic system 112, remote transmitter 114, and security transmitter 450. Schematic diagram 400 is shown to include several of the components of trainable transceiver unit 102 previously described with reference to FIG. 3. These components may operate in substantially the same way as described with respect to FIG. 3. In addition, schematic diagram 400 is shown to include RF circuit 410, antenna 412, and security transmitter 450.

In some embodiments, RF circuit 410 and antenna 412 may be configured to communicate with security transmitter 450. RF circuit 410 may provide dedicated transmit/receive functionality to security module 230. RF circuit 410 may receive a security input signal from security transmitter 450 over a wireless link. RF circuit 410 may then pass those security input signals to security module 230. Security module 230 may process the received security input signal to determine a security control signal. In some embodiments, RF circuit 410 is configured to operate with less power than RF circuit 312, allowing for limited-range communication with remote devices such as security transmitter 450, and also reducing a power demand for RF circuit 410 from battery 214 (e.g., when security transmitter 450 or a fob is a passive transmitter, intermittent operation of RF circuit 410 in response to an activation signal from a user may drain battery 214 more rapidly than desired). In some embodiments, RF circuit 410 is similar or identical to RF circuit 312, including being similar or identical in operational power. RF circuit 410 may also demand greater operational power than RF circuit 312, particularly if RF circuit 410 is intended to be used less frequently than RF circuit 312.

In some embodiments, security transmitter 450 may be a separate electronic device that transmits a security input signal to trainable transceiver unit 102. For example, security transmitter 450 may be a “fob” carried by an authorized operator of the vehicle in which trainable transceiver unit 102 is located. The fob may transmit a security code as the security input signal, such as a 40 bit string. A corresponding security code may be stored on trainable transceiver unit 102. Upon receiving a security input signal from security transmitter 450, security module 230 may compare the received security input signal to the security code stored on the trainable transceiver unit 102. If the two values match, the security module 230 may generate a security control signal with a value of “authorized.” If the two values do not match, security module 230 may generate a security control signal with a value of “not authorized.” In either case, security module 230 may transmit the generated security control signal to the microcontroller 310. In some embodiments, security module 230 may decrypt the received security input signal before comparing it to the stored security code.

Security module 230 may be configured to train to a security input signal from security transmitter 450. For example, trainable transceiver unit 102 may be placed in a security training mode in which trainable transceiver unit 102 receives a valid security input signal transmitted by security transmitter 450 and stores the valid security input signal in a storage medium of security module 230 and/or in memory 212 for reference in order to validate future security input signals for generating a security control signal. In some embodiments, the security training mode may be configured to store only one valid security input signal, regardless of source (e.g., a security input signal transmitted by security transmitter 450, a security input signal related to vibration patterns, etc.). As such, only the most recent security input signal trained to may be used for authentication, providing a strict limit on authentication. In other embodiments, the security training mode may store one valid security input signal for each source, or may store multiple valid security input signals for each source. A user may control operation of trainable transceiver unit 102 to determine the type of security training mode used. A specific clearance code may be required to initiate a security training mode, and may be required to select the type of security training mode used.

Security transmitter 450 may be provided for transmitting the security input signal to security module 230 in a variety of ways in various embodiments. In some embodiments, security transmitter 450 may be a passive transmitter. As such, security transmitter 450 may only transmit the security input signal to security module 230 upon first receiving a signal transmitted by RF circuit 410, RF circuit 312, or some other transmitter provided in trainable transceiver unit 102 or the vehicle in which it is located. In some embodiments, security transmitter 450 may be an active transmitter. As such, security transmitter 450 may transmit the security input signal to security module 230 without first receiving a signal from RF circuit 410, RF circuit 312, or any other transmitter provided in trainable transceiver unit 102 or the vehicle in which it is located. In such cases, security transmitter 450 may be provided with a user input device (e.g., a button). If provided, the user input device may allow the user to cause security transmitter 450 to transmit the security input signal to security module 230. In some embodiments, security transmitter 450 may be integrated with an existing active or passive key fob provided for operation of the vehicle in which the trainable transceiver unit 102 is present. In some embodiments, security transmitter 450 may be provided as an independent fob device having its own housing separate from any other electronic device provided for operation of the vehicle in which trainable transceiver unit 102 is present.

Advantageously, security transmitter 450 may be provided as a passive transmitter as described above. Security transmitter 450 may be configured to transmit the security input signal based on receiving an active transmission from trainable transceiver unit 102 or some other component of the vehicle. The active transmission may be provided with a transmission strength that only makes the active transmission receivable by security transmitter 450 within an area in and immediately adjacent to the vehicle. An authorized operator of the vehicle may attach security transmitter 450 to a keychain or other object that the authorized operator carries with him/her while operating the vehicle. In this way, trainable transceiver unit 102 may be disabled unless the authorized operator carrying security transmitter 450 is in or immediately adjacent to the vehicle. This may prevent an unauthorized person from causing transmission of control signals from trainable transceiver unit 102 when an authorized operator is not present. Therefore, an unauthorized person may be prevented from gaining access to a garage, secure neighborhood, or other location to which trainable transceiver unit 102 may generally be effective to permit access.

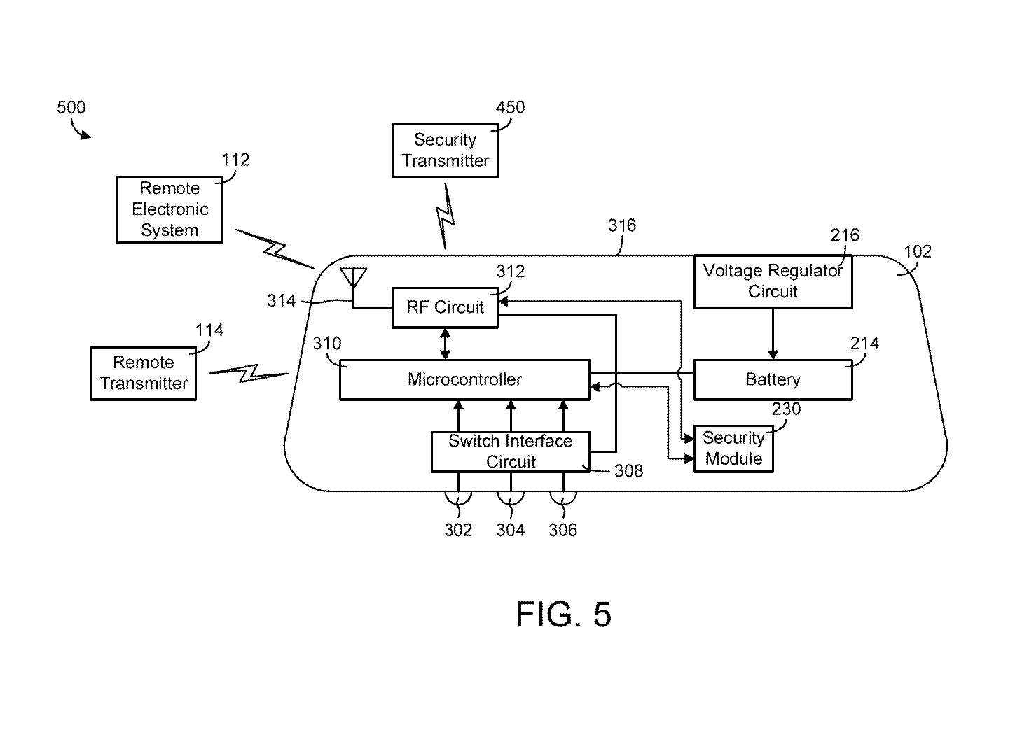

Referring now to FIG. 5, an electrical schematic diagram 500 of trainable transceiver unit 102 is shown, according to an exemplary embodiment. Schematic diagram 500 illustrates the data and power connections within trainable transceiver unit 102 as well the electronic data communications between trainable transceiver unit 102, remote electronic system 112, remote transmitter 114, and security transmitter 450. Schematic diagram 500 is shown to include several of the components of trainable transceiver unit 102 previously described with reference to FIG. 4. These components may operate in substantially the same way as descried with reference to FIG. 4, except as noted in the following description. In particular, trainable transceiver unit 102 of schematic diagram 500 does not contain RF circuit 410 or antenna 412. Instead, an additional communication line is provided between security module 230 and RF circuit 312.

In trainable transceiver unit 102 of FIG. 5, RF circuit 312 may be effective to receive a security input signal from security transmitter 450 as previously described with respect to RF circuit 410 in FIG. 4. RF circuit 312 may then transmit the security input signal to security module 230. In this way, trainable transceiver unit 102 of FIG. 5 may perform the same functions as that described with respect to FIG. 4, but security module 230 does not have a dedicated RF circuit for sending and receiving data to and from security transmitter 450. This configuration may be advantageous for limiting the additional hardware needed to be provided in trainable transceiver unit 102 in order to implement the security features provided by security module 230.

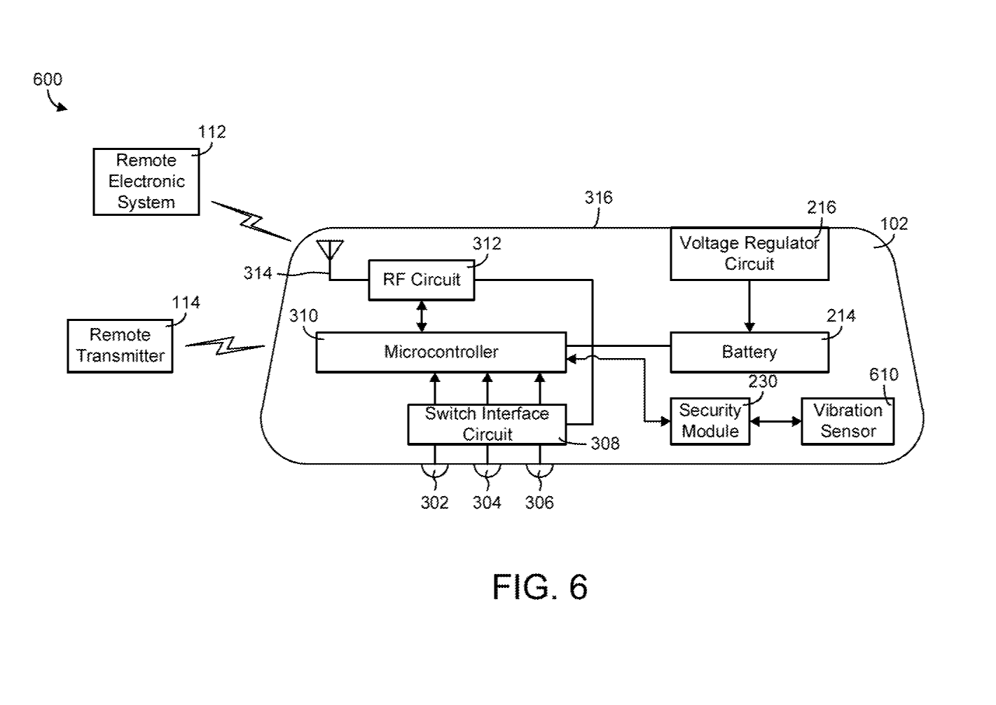

Referring now to FIG. 6, an electrical schematic diagram 600 of trainable transceiver unit 102 is shown, according to an exemplary embodiment. Schematic diagram 600 illustrates the data and power connections within trainable transceiver unit 102 as well the electronic data communications between trainable transceiver unit 102, remote electronic system 112, and remote transmitter 114. Schematic diagram 600 is shown to include several of the components of trainable transceiver unit 102 previously described with reference to FIG. 4. These components may operate in substantially the same way as descried with reference to FIG. 4, except as noted in the following description. In particular, trainable transceiver unit 102 of schematic diagram 500 does not contain RF circuit 410, antenna 412, or security transmitter 450, but it does contain vibration sensor 610.

In the embodiment of trainable transceiver unit 102 shown in FIG. 6, the security input signal received by security module 230 may be a vibration signal provided from vibration sensor 610. Vibration sensor 610 may detect physical vibrations of trainable transceiver unit 102, housing 316, the vehicle, other adjacent components, or any combination thereof. In such an embodiment, security module 230 may be configured to learn a vibration pattern of the vehicle in which trainable transceiver unit 102 is located. For example, security module 230 may record vibration signals provided by vibration sensor 610 over a period of time when the vehicle's motor is running Security module 230 may store these vibration signals as a type of security code. The stored vibration pattern may be unique with respect to other sources of vibration that can be caused in the vehicle (e.g., closing a car door). Therefore, the stored security code may indicate a vibration pattern expected when the motor of the vehicle is running

In some embodiments, a security training mode for identifying a vibration pattern for storage may require recording multiple vibration signals. For example, security module 230 may record multiple vibration signals at various time intervals (e.g., at fractions of seconds, every 1 second, every 5 seconds, etc.), and of various durations (e.g., for fractions of seconds, for 1 second, for 5 seconds, etc.). Security module 230 may use any of the recorded vibration signals for validation and authentication. Security module 230 may also analyze the recorded vibration signals to determine a composite vibration pattern having common characteristics of all recorded vibration signals, or of a subset thereof. Security module 230 may also record multiple vibration signals under various operating conditions. For example, security module 230 and trainable transceiver unit 102 may provide training instructions for operating the vehicle with the engine off, with the engine on but with no motion, with the engine on and with low speed motion (e.g., 5 miles per hour, etc.), in order to distinguish a vibration pattern corresponding to the engine on with no motion operating condition (which is to be used for authentication) from other vibration patterns.

In some embodiments, security module 230 may compare the stored security code to a received security input signal from vibration sensor 610 in order to determine whether the motor of the vehicle is currently running The received security input signal from vibration sensor 610 may be real-time or near real-time signals generated by vibration sensor 610 corresponding to vibrations detected by vibration sensor 610. If the received security input signal is sufficiently similar to the stored security code, security module 230 may determine that the motor of the vehicle is currently running If the motor of the vehicle is currently running, security module 230 may generate a security control signal with a value of “authorized.” If the motor of the vehicle is not currently running, security module 230 may generate a security control signal with a value of “not authorized.” In either case, security module 230 may transmit the generated security control signal to microcontroller 310.

Advantageously, security module 230 may generate the security control signal based on vibrations of the vehicle in order to only allow transmission of control signals from RF circuit 312 when the motor of the vehicle is running This approach may reflect an assumption that the motor of the vehicle will generally not be running unless an authorized operator has started the motor of the vehicle. Similarly, an unauthorized person is expected to not have a key or other device to start the motor of the vehicle. In this way, trainable transceiver unit 102 may be disabled unless the authorized operator has started the motor of the vehicle. This may prevent an unauthorized person from causing transmission of control signals from trainable transceiver unit 102 when an authorized operator is not present. Therefore, the unauthorized person may be prevented from gaining access to a garage, secure neighborhood, or other location to which trainable transceiver unit 102 may generally be effective to permit access.

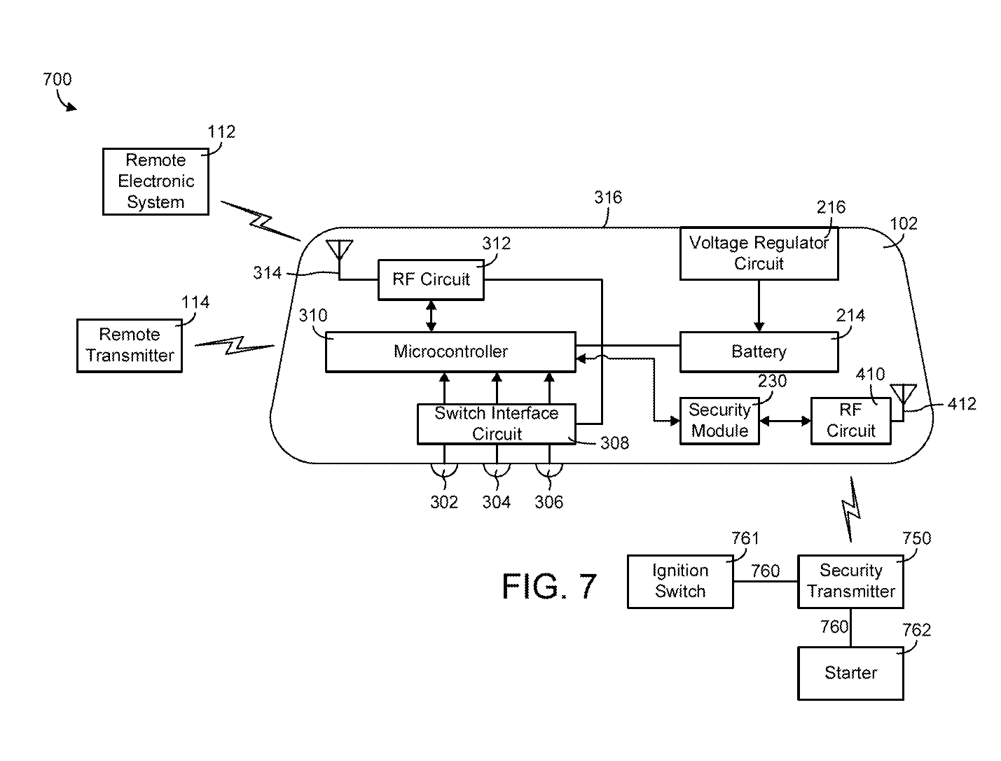

Referring now to FIG. 7, an electrical schematic diagram 700 of trainable transceiver unit 102 is shown, according to an exemplary embodiment. Schematic diagram 700 illustrates the data and power connections within trainable transceiver unit 102 as well the electronic data communications between trainable transceiver unit 102, remote electronic system 112, remote transmitter 114, and security transmitter 750. Schematic diagram 700 is shown to include several of the components of trainable transceiver unit 102 previously described with reference to FIG. 4. These components may operate in substantially the same way as descried with reference to FIG. 4, except as noted in the following description. In schematic diagram 700 does not contain security transmitter 450, but schematic diagram 700 is shown to further contain security transmitter 750, ignition line 760, ignition switch 761, and starter 762.

In the embodiment shown in FIG. 7, security transmitter 750 may be provided attached to, attached around, or otherwise placed adjacent to ignition line 760. Ignition line 760 is shown as extending between ignition switch 761 and starter 762. However, ignition line 760 may be provided between various other components of the vehicle in other embodiments. Notably, though, ignition line 760 is an electrical wire that carries different levels of current and/or voltage when the motor of the vehicle is not running versus when the motor of the vehicle is running For example, ignition line 760 may pass a first, lower level of current when the motor of the vehicle is not running Ignition line 760 may pass a second, higher level of current when the motor of the vehicle is running Security transmitter 750 may be configured to detect the current level passing along ignition line 760 based on the magnetic field generated around ignition line 760. For example, security transmitter 750 may be configured to identify when the magnetic field around ignition line 760 corresponds to the second, higher level of current when the motor of the vehicle is running When this magnetic field is identified, security transmitter 750 may transmit a security input signal to security module 230 by way of RF circuit 410 and antenna 412. In some embodiments, security transmitter 750 may be easily clipped onto ignition line 760 without requiring any electrical coupling to ignition line 760. A security training mode for security transmitter 750 may include recording signals when the vehicle is fully off, when the vehicle electrical systems have been activated but the motor of the vehicle is not running, and when the motor of the vehicle is running, in order to identify characteristics that distinguish the signal to be used for validation and authentication (e.g., when the motor is running) from other signals.

Advantageously, security module 230 may generate the security control signal based on whether security transmitter 750 indicates that the motor of the vehicle is running This approach may reflect an assumption that the motor of the vehicle will generally not be running unless an authorized operator has started the motor of the vehicle. Similarly, an unauthorized person is expected to not have a key or other device to start the motor of the vehicle. In this way, trainable transceiver unit 102 may be disabled unless the authorized operator has started the motor of the vehicle. This may prevent an unauthorized person from causing transmission of control signals from trainable transceiver unit 102 when an authorized operator is not present. Therefore, the unauthorized person may be prevented from gaining access to a garage, secure neighborhood, or other location to which trainable transceiver unit 102 may generally be effective to permit access.

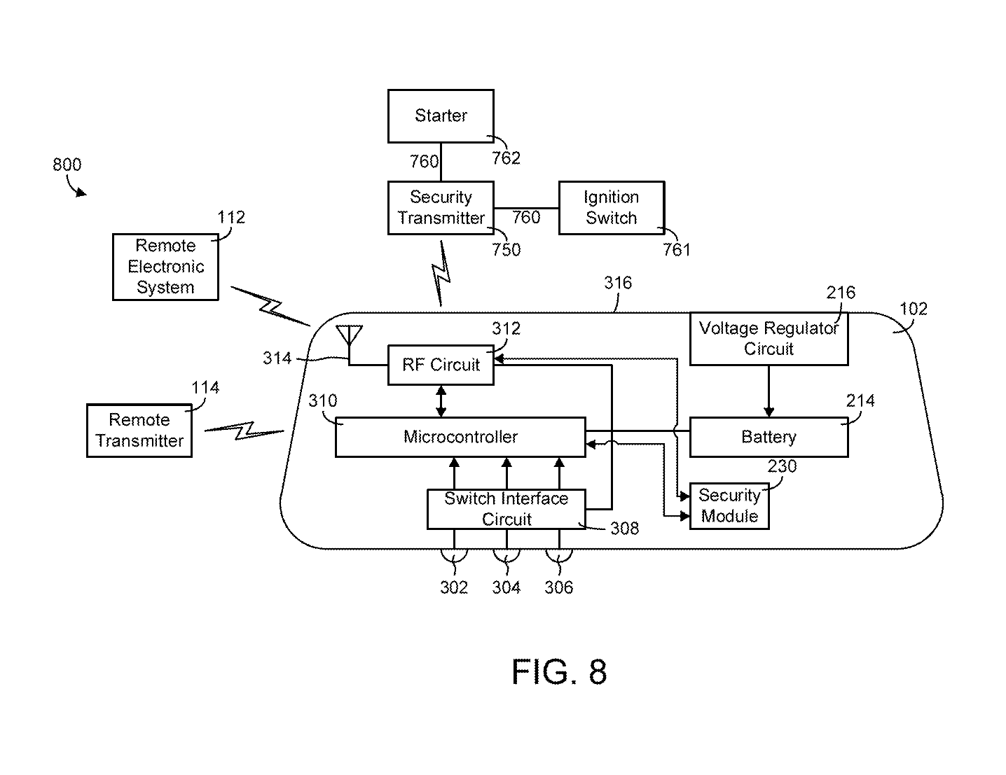

Referring now to FIG. 8, an electrical schematic diagram 800 of trainable transceiver unit 102 is shown, according to an exemplary embodiment. Schematic diagram 800 illustrates the data and power connections within trainable transceiver unit 102 as well the electronic data communications between trainable transceiver unit 102, remote electronic system 112, remote transmitter 114, and security transmitter 750. Schematic diagram 800 is shown to include several of the components of trainable transceiver unit 102 previously described with reference to FIG. 7. These components may operate in substantially the same way as descried with reference to FIG. 7, except as noted in the following description. In particular, trainable transceiver unit 102 of schematic diagram 800 does not contain RF circuit 410 or antenna 412. Instead, an additional communication line is provided between security module 230 and RF circuit 312.

In trainable transceiver unit 102 of FIG. 8, the RF circuit 312 may be effective to receive a security input signal from security transmitter 750 as previously described with respect to RF circuit 410 in FIG. 7. RF circuit 312 may then transmit the security input signal to security module 230. In this way, trainable transceiver unit 102 of FIG. 8 may perform the same functions as that described with respect to FIG. 7, but security module 230 does not have a dedicated RF circuit for sending and receiving data to and from security transmitter 750. This configuration may be advantageous for limiting the additional hardware needed to be provided in trainable transceiver unit 102 in order to implement the security features provided by security module 230.

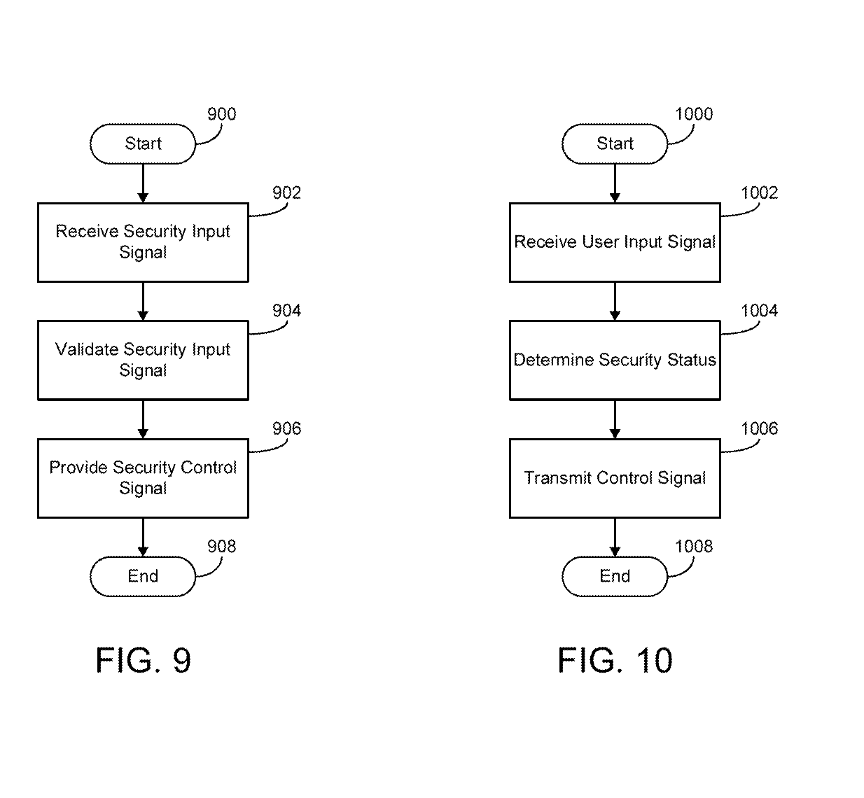

Referring now to FIG. 9, a flowchart of a process for a trainable transceiver unit in a vehicle is shown, according to an exemplary embodiment. The process begins at step 900.

The process continues at step 902. At step 902, a security input signal is received. This step may include receiving the security input signal at a security module provided in the trainable transceiver unit. This step may include receiving a security input signal from a security transmitter device over a wireless link. This step may include receiving a security input signal from an active or passive fob device. This step may include receiving a security input signal from a vibration sensor. This step may include receiving a security input signal that is based on a stored security code on a security transmitter device. This step may include receiving a security input signal that is based on a vibration of the vehicle. This step may include receiving a security input signal that is based on a current level passing through an ignition line of the vehicle.

The process continues at step 904. At step 904, the security input signal is validated. This step may include a security module comparing the security input signal to a stored security code that is stored on a storage medium of the trainable transceiver unit. This step may include a security module comparing the security input signal to a stored security code that indicates a valid series of bits. This step may include a security module comparing the security input signal to a stored vibration pattern for the vehicle. This step may include decrypting the security input signal and comparing the decrypted value to a security code that is stored on a storage medium of the trainable transceiver unit. In some embodiments, step 904 may be omitted from the process of this figure.

The process continues at step 906. At step 906, a security control signal is provided. This step may include generating the security control signal based on a result of step 904. This step may include generating the security control signal based on the value of the received security input signal. This step may include transmitting the security control signal to a microprocessor, control circuit, or other component of the trainable transceiver unit. This step may include generating an “authorized” value of the security control signal if the received security input signal matches a security code that is stored on a storage medium of the trainable transceiver unit. This step may include generating a “not authorized” value of the security control signal if the received security input signal does not match a security code that is stored on a storage medium of the trainable transceiver unit. This step may include generating an “authorized” value of the security control signal if the received security input signal indicates that the motor of the vehicle is running This step may include generating a “not authorized” value of the security control signal if the received security input signal indicates that the motor of the vehicle is not running The process ends at step 908.

Referring now to FIG. 10, a flowchart of a process for a trainable transceiver unit in a vehicle is shown, according to an exemplary embodiment. The process begins at step 1000.

The process continues at step 1002. At step 1002, a user input signal is received. This step may include receiving the user input signal at a microcontroller of the trainable transceiver unit. This step may include receiving the user input signal indicating a particular stored control code. This step may include receiving the user input signal indicating a particular stored control code that the user desires to transmit from the trainable transceiver unit to a remote electronic system. This step may include receiving the user input signal as a result of the user pressing a button provided as part of the trainable transceiver unit.

The process continues at step 1004. At step 1004, a security status is determined. This step may include a microcontroller requesting a security control signal from a security module provided as part of the trainable transceiver unit. This step may include a microcontroller observing a security control signal presently being received from a security module provided as part of the trainable transceiver unit. This step may include a microcontroller retrieving a security control signal previously received from a security module provided as part of the trainable transceiver unit. This step may include a microcontroller determining that the current security status is “authorized” or not “not authorized” based on a security control signal generated by a security module provided as part of the trainable transceiver unit.

The process continues at step 1006. At step 1006, a control signal is transmitted. This step may include the trainable transceiver unit transmitting a control signal indicated by the received user input signal. This step may include the trainable transceiver unit transmitting a control signal to a remote electronic system. This step may include a microcontroller of the trainable transceiver unit transmitting a control signal indicated by the received user input signal based on having determined a security status in step 1004. This step may include a microcontroller of the trainable transceiver unit transmitting a control signal indicated by the received user input signal based on having determined that the security status is “authorized” in step 1004. In some embodiments, when the security status is determined to be “not authorized” in step 1004, step 1006 may be omitted. The process ends at step 1008.

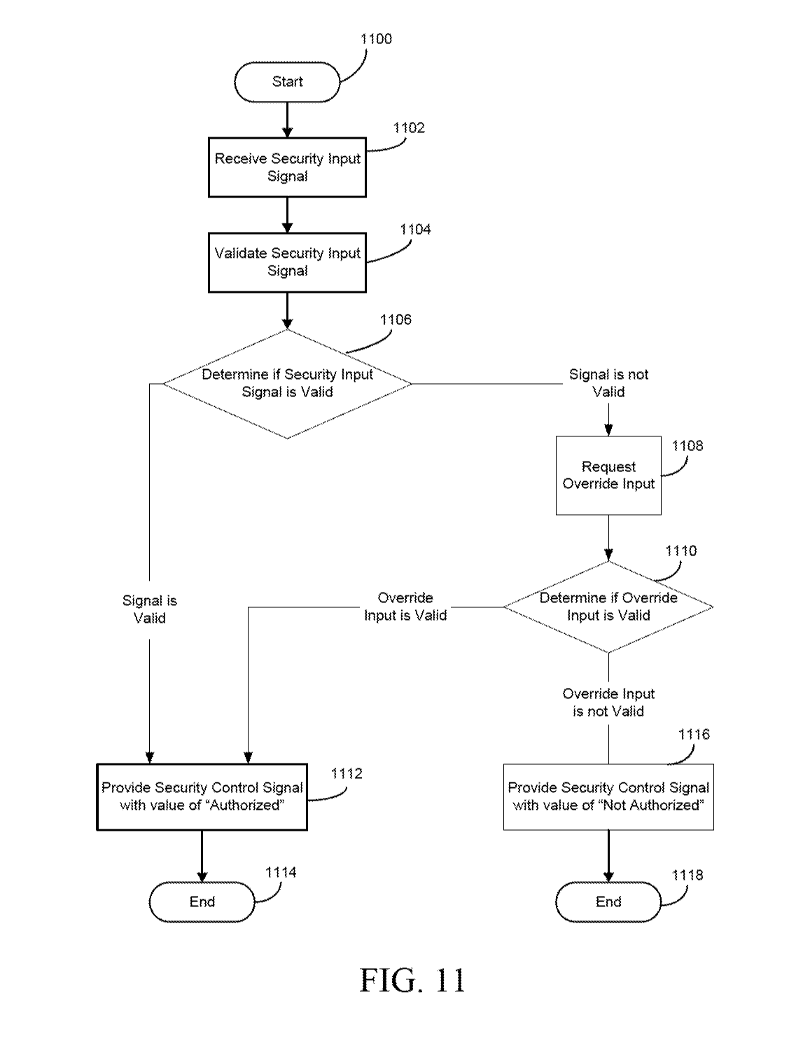

Referring now to FIG. 11, a flow diagram of a process of generating a security control signal for a trainable transceiver unit in a vehicle is shown, according to an exemplary embodiment. The process begins at step 1100.

The process continues at step 1102. At step 1102, a security input signal is received. This step may include receiving the security input signal at a security module provided in the trainable transceiver unit. This step may include receiving a security input signal from a security transmitter device over a wireless link. This step may include receiving a security input signal from an active or passive fob device. This step may include receiving a security input signal from a vibration sensor. This step may include receiving a security input signal that is based on a stored security code on a security transmitter device. This step may include receiving a security input signal that is based on a vibration of the vehicle. This step may include receiving a security input signal that is based on a current level passing through an ignition line of the vehicle.

The process continues at step 1104. At step 1104, the security input signal is validated. This step may include a security module comparing the security input signal to a stored security code that is stored on a storage medium of the trainable transceiver unit. This step may include a security module comparing the security input signal to a stored security code that indicates a valid series of bits. This step may include a security module comparing the security input signal to a stored vibration pattern for the vehicle. This step may include decrypting the security input signal and comparing the decrypted value to a security code that is stored on a storage medium of the trainable transceiver unit.

The process continues at step 1106. At step 1106, it is determined if the security input signal is valid based on step 1104. If the security input signal is not valid, then the trainable transceiver unit requests an override input at step 1108. For example, the trainable transceiver unit may provide a visual and/or audible alert indicating that the security input was not valid. The override input may be provided as a repeat of an original security code, such as by user input provided to activate an active security transmitter or fob. The override input may be a specific security code to be provided using a user interface of the trainable transceiver unit. Step 1108 thus allows a user to cause authentication in the event that an expected authentication procedure is not proceeding properly, without compromising the security provided by the authentication process. In some embodiments, a time limit may be imposed for receiving an override input. For example, the override input may be required to be received at the trainable transceiver unit within 1 minute, within 30 seconds, within 10 seconds, within 1 second, etc., of the request for an override input. In some embodiments, a limit may be provided on the number of times an override input may be provided. For example, after a number of attempts (e.g., 5 attempts, 3 attempts, 1 attempt, etc.), an override input may no longer be received.

The process continues at step 1110. At step 1110, it is determined whether the received override input is valid. For example, the override input may be compared to an override input stored in a storage medium of the trainable transceiver unit. If the override input is provided as an original security input signal, such as a signal from a security transmitter or fob, the override input may be compared to an appropriate input signal stored in a storage medium of the trainable transceiver unit.

If the security input signal is determined to be valid at 1106, or if the override input is determined to be valid at 1110, then the process continues at step 1112. At step 1112, an “authorized” security control signal is provided. This step may include generating the security control signal based on a result of step 1106 or step 1110. This step may include generating the security control signal based on the value of the received security input signal or override input. This step may include transmitting the security control signal to a microprocessor, control circuit, or other component of the trainable transceiver unit. This step may include generating an “authorized” value of the security control signal if the received security input signal matches a security code that is stored on a storage medium of the trainable transceiver unit. This step may include generating an “authorized” value of the security control signal if the received security input signal indicates that the motor of the vehicle is running This step may include generating an “authorized” value of the security control signal if the override input signal matches an override input that is stored on a storage medium of the trainable transceiver unit. The process ends at step 1114.

If the override input is determined to not be valid at 1110, then the process continues at step 1116. At step 1116, a “not authorized” security control signal is provided. This step may include generating the security control signal based on a result of step 1106 or step 1110. This step may include generating the security control signal based on the value of the received security input signal or override input. This step may include transmitting the security control signal to a microprocessor, control circuit, or other component of the trainable transceiver unit. This step may include generating a “not authorized” value of the security control signal if the received security input signal does not match a security code that is stored on a storage medium of the trainable transceiver unit. This step may include generating a “not authorized” value of the security control signal if the received security input signal indicates that the motor of the vehicle is not running This step may include generating a “not authorized” value of the security control signal if the received override input indicates an invalid override attempt.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A transmitter device for mounting to a vehicle and for sending a transmission to a remote system, comprising:
a processing circuit;
a transmitter; and
a battery powering the processing circuit and the transmitter;
wherein the processing circuit is only configured to use the transmitter to send the transmission to the remote system upon determining at least one of: (a) a user's portable electronic device is near the vehicle, and (b) the vehicle is powered on.

2. The transmitter of claim 1, further comprising:
a secondary transceiver configured for short range wireless communication with the user's portable electronic device, wherein the user's portable electronic device is at least one of a mobile phone, a smart watch, and a key fob.

3. The transmitter of claim 1, further comprising:
a secondary transceiver configured for short range wireless communication, wherein the secondary transceiver is configured to connect to a transceiver of the vehicle and to indicate to the processing circuit when wireless communication of the vehicle is active; wherein the processing circuit is configured to authorize use of the transmitter in response to the indication that wireless communication of the vehicle is active.

4. The transmitter of claim 1, further comprising:
a vibration sensor in communication with the processing circuit and configured to sense vibration of a vehicle with a started engine, wherein the processing circuit and the vibration sensor operate to prevent transmission to the remote system unless the vibration indicates the engine has started.

5. The transmitter of claim 4, further comprising a secondary transceiver, wherein the vibration sensor is a wireless module that communicates with the secondary transceiver to complete the communication of information from the vibration sensor to the processing circuit.

6. The transmitter of claim 1, further comprising an ignition sensor configured to sense power in the ignition line of the vehicle, wherein the processing circuit is in communication with the ignition sensor, and the processing circuit is configured to authorize use of the transmitter in response to sensing power in the ignition line of the vehicle.

7. The transmitter of claim 6, further comprising a secondary transceiver, wherein the ignition sensor comprises a wireless module for communicating information regarding the ignition state of the vehicle to the secondary transceiver.

8. The transmitter of claim 1, further comprising a user input interface configured to transmit a user input to the processing circuit, wherein the processing circuit is configured to compare the user input against a valid override input stored at the processing circuit, and wherein the processing circuit is further configured to use the transmitter to send the transmission in response to determining that the user input is valid.

9. The transmitter of claim 1, further comprising a secondary transceiver having a lower operational power than the transmitter, wherein the secondary transceiver is configured to communicate with a passive security transmitter and receive a security code from the passive security transmitter.

10. A transmitter device for activating a remote system, comprising:
a processing circuit;
a transmitter coupled to the processing circuit;
a battery powering the processing circuit and the transmitter; and
a plurality of buttons coupled to the processing circuit;
wherein the processing circuit is configured to allow a transmission from the transmitter to the remote system in response to a determination that a user has entered a correct multi-button code at the plurality of buttons.

11. The transmitter of claim 10, wherein a subsequent button press triggers the actual transmission after the transmission has been allowed by the correct multi-button code.

12. The transmitter of claim 10, wherein the last button pressed in the multi-button code activates a transmission previously stored in connection with that button.

13. The transmitter of claim 10, wherein the multi-button code differs from other possible multi-button codes and wherein different multi-button codes are associated with different transmissions to be made from the transmitter to the remote system.

14. The transmitter of claim 10, wherein the transmitter is integrated into a rear view mirror.

15. A trainable transceiver unit for mounting in a vehicle, the trainable transceiver unit comprising:
a transmitter configured to transmit a remote control signal for controlling operation of a remote electronic system;
a user input interface configured to receive a request for transmission of the remote control signal;
a security module configured to receive a security input signal, compare the security input signal to a stored valid security code, and transmit a security control signal to a processing circuit based on the comparison; and
the processing circuit configured to prevent operation of the transmitter unless the security control signal indicates operation of the transmitter is authorized.

16. The trainable transceiver unit of claim 15, wherein the security input signal includes one of a security signal received from a security transmitter, a vibration signal received from a vibration sensor, an ignition signal received from a power sensor configured to detect current in an ignition line of the vehicle, and an override code entered at the user input interface.

17. The trainable transceiver unit of claim 16, wherein the security module is configured to perform a security training mode for storing a valid vibration pattern, the valid vibration pattern determined based on vibration signals recorded during different operating conditions and an indication of an operation condition corresponding to a valid vibration signal.

18. The trainable transceiver unit of claim 16, wherein the security module is configured to store at least one valid security code corresponding to each of the security transmitter, the vibration sensor, and the power sensor during a security training mode.

19. The trainable transceiver unit of claim 15, wherein the security module is configured to store a valid security code during a security training mode, and the processing circuit comprises a read-only memory configured to store a valid override code.

20. The trainable transceiver unit of claim 15, wherein the security module is configured to store only one valid security code received during a most recent security training mode.
